(19) United States
(12) Patent Application Publication
(10) Pub. No.: US 2026/0068935 A1
(43) Pub. Date: Mar. 12, 2026

(54) AEROSOL-GENERATING DEVICE

(71) Applicant: KT&G CORPORATION, Daejeon (KR)

(72) Inventors: Chulho JANG, Buchun-si (KR); Jungho KIM, Seoul (KR); Sangcheol PARK, Suwon-si (KR); Jangwon SEO, Yongin-si (KR); Wonkyeong LEE, Guri-si (KR); Jinchul JUNG, Daejeon (KR)

(73) Assignee: KT&G CORPORATION, Daejeon (KR)

(21) Appl. No.: 19/254,901

(22) Filed: Jun. 30, 2025

(30) Foreign Application Priority Data
Sep. 11, 2024 (KR) 10-2024-0123742
Nov. 25, 2024 (KR) 10-2024-0169924

(51) Int. Cl. A24F 40/46; A24F 40/20; A24F 40/51; A24F 40/57; A24F 40/65; H05B 6/72; H05B 6/76

(52) U.S. Cl. CPC A24F 40/46; H05B 6/72; H05B 6/76; A24F 40/20; A24F 40/51; A24F 40/57; A24F 40/65

(57) ABSTRACT

An aerosol-generating device is disclosed. The aerosol-generating device includes a body providing an insertion space in which an aerosol-generating article is accommodated, an antenna disposed adjacent to the insertion space and configured to radiate microwaves that dielectrically heat the aerosol-generating article into the insertion space, and a controller configured to control a frequency of the microwaves radiated from the antenna, wherein the antenna has a changeable length and shape, and the controller is configured to change the frequency radiated from the antenna by controlling at least one of the length or the shape of the antenna to be changed.

### CROSS-REFERENCE TO THE RELATED APPLICATION

This application claims priority from Korean Patent Applications No. 10-2024-0123742, filed on Sep. 11, 2024, and No. 10-2024-0169924, filed on Nov. 25, 2024 in the Korean Intellectual Property Office, the disclosure of which is incorporated herein by reference in its entirety.

### BACKGROUND OF THE DISCLOSURE

### 1. Field of the Disclosure

The present disclosure relates to an aerosol-generating device.

### 2. Description of the Related Art

An aerosol-generating device is a device that extracts certain components from a medium or a substance through an aerosol. The medium may contain a multicomponent substance. The substance contained in the medium may be a multicomponent flavoring substance. For example, the substance contained in the medium may include a nicotine component, an herbal component, and/or a coffee component. Recently, various studies on aerosol-generating devices have been conducted.

An aerosol-generating device that heats an aerosol-generating substance using a dielectric heating method radiates microwaves into an insertion space to heat the aerosol-generating substance in an aerosol-generating article. In order to maximize heating efficiency of the aerosol-generating substance, microwave resonance needs to occur in the insertion space. The microwave resonance may vary depending on the quantity of a dielectric contained in the inserted aerosol-generating article, etc. In particular, as inhalation progresses and a medium, moisturizer, etc. in the aerosol-generating article is consumed, resonance conditions may vary.

When the resonant frequency at which microwave resonance occurs changes, a frequency radiated from an antenna needs to be changed to match the resonant frequency. However, a conventional aerosol-generating device has problems in that the frequency radiated from the antenna cannot be changed in response to change in a fluctuating resonant frequency, resulting in lower heating efficiency or malfunction or failure of the device due to reflected waves that are not absorbed by the medium, the moisturizer, etc.

### SUMMARY OF THE DISCLOSURE

It is an object of the present disclosure to solve the above and other problems.

It is another object of the present disclosure to provide an aerosol-generating device configured to perform a control operation so that at least one of a length or a shape of an antenna is changed.

It is another object of the present disclosure to provide an aerosol-generating device including a plurality of tracks on an antenna and including a track switch that electrically connects or disconnects tracks among the respective tracks.

It is another object of the present disclosure to provide an aerosol-generating device including a driver connected to one end of an antenna to extend or shorten the antenna in one direction.

It is another object of the present disclosure to provide an aerosol-generating device configured to change an output RF signal and a length or a shape of an antenna based on power of reflected waves.

In accordance with an aspect of the present disclosure for accomplishing the above objects, an aerosol-generating device includes a body providing an insertion space in which an aerosol-generating article is accommodated, an antenna disposed adjacent to the insertion space and configured to radiate microwaves that dielectrically heat the aerosol-generating article into the insertion space, and a controller configured to control a frequency of the microwaves radiated from the antenna, wherein the antenna has a changeable length and shape, and the controller is configured to change the frequency radiated from the antenna by controlling at least one of the length or the shape of the antenna to be changed.

### BRIEF DESCRIPTION OF THE DRAWINGS

FIG. 1 is a block diagram of an aerosol-generating device according to an embodiment of the present disclosure;

FIG. 2 illustrates the aerosol-generating device according to the embodiment of the present disclosure;

FIG. 3 is a drawing illustrating a radiating unit according to an embodiment of the present disclosure;

FIG. 4 is a drawing illustrating a track and a switch of an antenna according to an embodiment of the present disclosure;

FIG. 5 is a drawing illustrating change in a length and a shape of the antenna by a switch operation according to an embodiment of the present disclosure;

FIG. 6 is a drawing illustrating a track and a switch of an antenna according to an embodiment of the present disclosure;

FIG. 7 is a drawing illustrating change in a length and a shape of the antenna by a switch operation according to an embodiment of the present disclosure;

FIG. 8 is a drawing illustrating the antenna and a driver according to an embodiment of the present disclosure;

FIG. 9 is a drawing illustrating change in a length and a shape of the antenna by a driver operation according to an embodiment of the present disclosure; and

FIG. 10 and FIG. 11 are flowcharts illustrating microwave frequency change control according to an embodiment of the present disclosure.

### DETAILED DESCRIPTION OF THE PREFERRED EMBODIMENTS

Hereinafter, the embodiments disclosed in the present specification will be described in detail with reference to the accompanying drawings. The same or similar elements are denoted by the same reference numerals even though they are depicted in different drawings, and redundant descriptions thereof will be omitted. With regard to the description of the drawings, similar reference numerals may be used to refer to similar or related elements.

In the following description, with respect to constituent elements used in the following description, the suffixes “module” and “unit” are used only in consideration of facilitation of description, and do not have mutually distinguished meanings or functions. As used herein, the suffix “module” or “unit” may include a unit implemented in hardware, software, or firmware, and may be used interchangeably with other terms, for example, “logic,” “logic block,” “part,” or “circuitry.” A “module” or a “unit” may be a single integral component, or a minimum unit or part thereof, adapted to perform one or more functions. For example, the “module” or the “unit” may be implemented in the form of an application-specific integrated circuit (ASIC).

In addition, in the following description of the embodiments disclosed in the present specification, a detailed description of known functions and configurations incorporated herein will be omitted when the same may make the subject matter of the embodiments disclosed in the present specification rather unclear. In addition, the accompanying drawings are provided only for a better understanding of the embodiments disclosed in the present specification and are not intended to limit the technical ideas disclosed in the present specification. Therefore, it should be understood that the accompanying drawings include all modifications, equivalents, and substitutions within the scope and spirit of the present disclosure.

It will be understood that although the terms “first”, “second”, etc., may be used herein to describe various components, these components should not be limited by these terms. These terms are only used to distinguish one component from another component.

It will be understood that when a component is referred to as being “connected to” or “coupled to” another component, it may be directly connected to or coupled to another component, or intervening components may be present. On the other hand, when a component is referred to as being “directly connected to” or “directly coupled to” another component, there are no intervening components present.

As used herein, the singular form is intended to include the plural forms as well, unless the context clearly indicates otherwise.

Embodiments as set forth herein may be implemented as software including one or more instructions that are stored in a storage medium (e.g., a memory 17) that is readable by a machine (e.g., the aerosol-generating device 1). For example, a processor (e.g., the controller 12) of the machine (e.g., the aerosol-generating device 1) may invoke at least one of the one or more instructions stored in the storage medium, and may execute the same. This allows the machine to be operated to perform at least one function according to the at least one instruction invoked. The one or more instructions may include code generated by a compiler or code executable by an interpreter. The machine-readable storage medium may be provided in the form of a non-transitory storage medium. Here, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

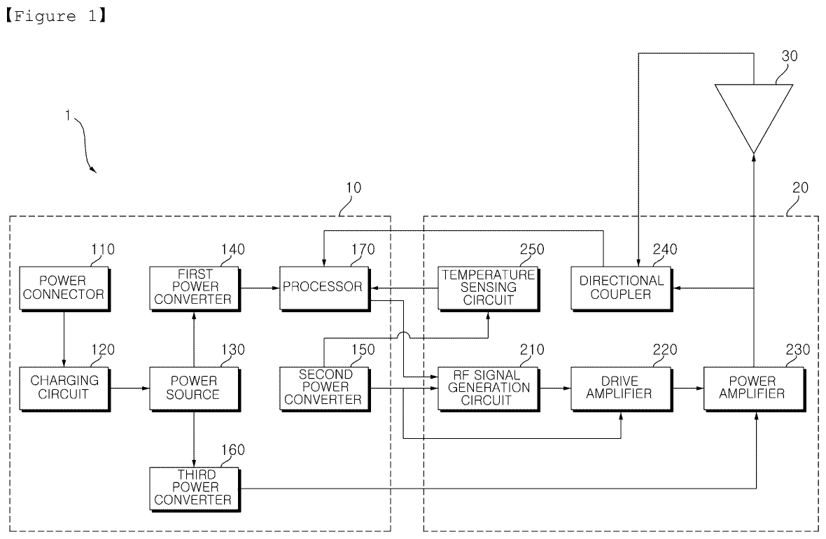

FIG. 1 is a block diagram of an aerosol-generating device 1 according to an embodiment.

In accordance with an embodiment, the aerosol-generating device 1 may include a controller 10, a source unit 20, and a radiating unit 30. The controller 10 may mean a circuit for controlling the basic operation of the aerosol-generating device 1. The source unit 20 may mean a circuit for generating a radio frequency (RF) signal under control of the controller 10. The radiating unit 30 may be an apparatus for radiating the RF signal generated by the source unit 20 to a space into which an aerosol-generating article is inserted (hereinafter, an insertion space) in the form of electromagnetic waves. The radiated electromagnetic waves (e.g., RF signal) may cause charges or ions of a dielectric (e.g., glycerin) contained in the aerosol-generating article to vibrate or rotate, and the aerosol-generating article may be heated as the dielectric is heated by frictional heat generated in the process of the charges or ions vibrating or rotating. In other words, the aerosol-generating device 1 may be an apparatus for generating an aerosol by heating the aerosol-generating article using a dielectric heating method.

In an example, the controller 10 may include a power connector 110, a charging circuit 120, a power source 130, a first power converter 140, a second power converter 150, a third power converter 160, and/or a processor 170. In addition, the source unit 20 may include an RF signal generation circuit 210, a drive amplifier 220, a power amplifier 230, a directional coupler 240, and/or a temperature sensing circuit 250. However, it will be understood by a person having ordinary skill in the art related to the present disclosure that, depending on the design of the aerosol-generating device 1, some of the components shown in FIG. 1 may be omitted or new components may be added.

The power connector 110 may mean a physical connection device that is electrically connected to an electronic device or system external to the aerosol-generating device 1 (e.g., an external power source) and used to transmit and receive power. For example, the power connector 110 may receive power from the external power source, and may transmit the received power to a component that needs to be charged (e.g., the power source 130). The power connector 110 may provide a path for data transmission. The aerosol-generating device 1 may transmit and receive data to and from the external electronic device or system (e.g., smartphone or computer) via the power connector 110. The power connector 110 may include a universal serial bus (USB) power connector and a direct current (DC) power connector. In an example, the power connector 110 may be a USB—C type connector capable of supplying a direct current voltage (DC) of 9 volts (V) at a current of 1 ampere (A), but the present disclosure is not necessarily limited thereto. The power connector 110 may include an interface for wirelessly transmitting and receiving power.

The charging circuit 120 may mean a circuit for charging the power source 130. The charging circuit 120 may charge the power source 130 using power transmitted from the power connector 110. In an example, the charging circuit 120 may be implemented as a charger IC, which is an integrated circuit (IC) that functions to efficiently and safely charge the power source 130. By monitoring the voltage, current, and/or temperature of the power source 130, the charging circuit 120 may monitor the charging state of the power source 130 or optimize the charging process. For example, the charging circuit 120 may detect the state of the power source 130 and provide appropriate charging voltage and current to prevent overcharging or over-discharging.

The power source 130 may supply power for operation of the aerosol-generating device 1. The power source 130 may include one or more rechargeable batteries. The power source 130 may supply power to the radiating unit 30 such that the radiating unit 30 can radiate electromagnetic waves (e.g., RF signal) to the insertion space to heat the aerosol-generating article. Here, the supply of power to the radiating unit 30 may be synonymous with the supply of power to the source unit 20. In addition, the power source 130 may supply power for operation of the processor 170, the RF signal generation circuit 210, the drive amplifier 220, the power amplifier 230, and the temperature sensing circuit 250. In an example, the power source 130 may be, but is not limited to, a lithium polymer (LiPoly) battery. The power source 130 may also be a replaceable (removable) battery (hereinafter, a removable battery). The removable battery may be mounted in a battery compartment provided in the aerosol-generating device 1, or may be removed from the battery compartment. The removable battery may be wired and/or wirelessly charged.

The aerosol-generating device 1 may include a power conversion circuit for converting power supplied from the power source 130 into power (e.g., voltage and/or current) suitable for other components. The power conversion circuit may include at least one of a buck-converter, a buck-boost converter, a boost converter, a Zener diode, and a low-dropout (LDO) regulator. In addition, the power conversion circuit may include a DC/AC converter (e.g., an inverter) as needed.

In an example, the aerosol-generating device 1 may include a first power converter 140, a second power converter 150, and a third power converter 160. The first power converter 140 may be an LDO regulator for supplying suitable power (e.g., DC 3.3 V) to the processor 170, the second power converter 150 may be a buck-boost converter for supplying suitable power (e.g., DC 5 V) to the temperature sensing circuit 250, the RF signal generation circuit 210, and the drive amplifier 220, and the third power converter 160 may be a boost converter for supplying suitable power (e.g., DC 12 V/25 W) to the power amplifier 230.

However, the first power converter 140, the second power converter 150, and the third power converter 160 are not limited to the foregoing examples, and may include other types of power conversion circuits. In addition, although FIG. 1 shows that the aerosol-generating device 1 includes three power converters, the aerosol-generating device 1 may include more than three power converters or less than three power converters. In an example, at least some of the first power converter 140, the second power converter 150, and the third power converter 160 may be integrated into a single power converter.

The processor 170 may control the overall operation of the aerosol-generating device 1. For example, the processor 170 may directly or indirectly control charging and discharging of the power source 130 using the charging circuit 120. In addition, the processor 170 may regulate the voltage and/or current output by the power conversion circuit by regulating the frequency and/or duty ratio of a current pulse input to at least one switching element of the power conversion circuit. The processor 170 may generally control the operation of other components, a description of which will follow, in addition to the components described above.

The processor 170 may be implemented as an array of multiple logic gates or as a combination of a general purpose micro controller unit (MCU) (or, microprocessor) and a memory storing programs that may be executed by the MCU. In addition, it will be understood by a person having ordinary skill in the art to which this embodiment pertains that the processor 170 can be implemented in other forms of hardware.

The RF signal generation circuit 210 may generate an RF signal based on power transmitted from the power source 130 or the second power converter 150. The RF signal may mean a signal having a frequency within a range of 300 MHz to 300 GHz. In an example, the RF signal may have a frequency of 1 GHz to 100 GHz. In addition, the RF signal may have a frequency within an Industrial Scientific and Medical equipment (ISM) band, such as a frequency of 915 MHz, 2.45 GHz, and/or 5.8 GHz.

The RF signal generation circuit 210 may include a voltage controlled oscillator (VCO) for generating RF signals having different frequencies depending on input voltage. The RF signal generation circuit 210 may receive a control signal (e.g., a DC signal) from the processor 170 and generate an RF signal having a frequency corresponding to the received control signal. The processor 170 may store control signals corresponding to desired frequencies in the form of a look-up table, or may calculate a control signal corresponding to a desired frequency in real time through at least one operation.

In an example, the aerosol-generating device 1 may further include a digital to analog (D/A) converter for converting a digital control signal output from the processor 170 into an analog control signal. The RF signal generation circuit 210 may receive an analog control signal and generate an RF signal having a frequency corresponding to the received analog control signal.

The drive amplifier 220 may amplify the RF signal generated by the RF signal generation circuit 210. For example, the drive amplifier 220 may amplify a signal level (e.g., amplitude) of the RF signal to provide a suitable input signal to the component in the next step (e.g., the power amplifier 230). The drive amplifier 220 may minimize distortion of the signal by maintaining high linearity. However, since the drive amplifier 220 is an amplifier focused on increasing the signal level, the drive amplifier may provide relatively low output power.

The power amplifier 230 may amplify power of the RF signal received from the drive amplifier 220. The power amplifier 230 may be an amplifier focused on providing sufficient power to an end output device (e.g., the radiating unit 30). For example, the power amplifier 230 may provide an RF signal with high power to the radiating unit 30 such that the radiating unit 30 can radiate electromagnetic waves to the insertion space to heat the aerosol-generating article. The power amplifier 230 may perform an amplification operation using power received through the third power converter 160 that provides higher power and/or voltage than the second power converter 150.

Each of the drive amplifier 220 and the power amplifier 230 may include a transistor, such as a bipolar junction transistor (BJT) or a field effect transistor (FET), or a vacuum tube. In an example, each of the drive amplifier 220 and power amplifier 230 may be, but is not necessarily limited to, a gallium nitride (GaN) transistor capable of handling high efficiency, high speed, and high voltage. Each of the drive amplifier 220 and power amplifier 230 may include an operational amplifier.

Although the drive amplifier 220 and the power amplifier 230 are shown as separate amplifiers in FIG. 1, the drive amplifier 220 and the power amplifier 230 may be integrated into a single amplifier. In addition, the drive amplifier 220 and/or the power amplifier 230 may include a plurality of amplifiers connected in series, in parallel, and/or in series and parallel.

The radiating unit 30 may include at least one antenna for radiating electromagnetic waves to the space. The at least one antenna may have a size and shape suitable for the size and shape of the aerosol-generating article. For example, if the aerosol-generating article is cylindrical, the at least one antenna may be formed in a tubular shape surrounding the cylindrical aerosol-generating article. Here, the shape of the antenna being tubular may mean that the overall shape of the antenna is tubular. In other words, if the antenna is made of a metal (e.g., SUS) track, this may mean that the overall shape of the track is tubular. The shape of the at least one antenna is not limited to the foregoing examples and may include a variety of shapes, such as a flat plate shape and a curved plate shape.

The radiating unit 30 may radiate electromagnetic waves (e.g., an amplified RF signal or a transmitted RF signal) to the insertion space to heat the aerosol-generating article. In order for the heating efficiency of the aerosol-generating article to be maximized, resonance of the electromagnetic waves must occur in the insertion space. The resonance condition (e.g., resonance frequency) of the insertion space may vary depending on the amount of dielectric contained in the inserted aerosol-generating article. By adjusting a control signal input to the RF signal generation circuit 210, the processor 170 may control the frequency of the RF signal generated by the RF signal generation circuit 210 so as to correspond to or approach the resonance condition of the insertion space. The processor 170 may use the directional coupler 240 to obtain information about the resonance condition of the insertion space.

The directional coupler 240 may mean a passive element having a waveguide structure capable of separating incident and reflected waves. The directional coupler 240 may receive an RF signal transmitted from the power amplifier 230 toward the radiating unit 30 and electromagnetic waves reflected from the insertion space after being radiated by the radiating unit 30. The directional combiner 240 may separate the transmitted RF signal and the reflected electromagnetic waves and transmit the same to the processor 170.

In an example, the aerosol-generating device 1 may further include an analog to digital (A/D) converter for converting an analog output of the directional coupler 240 into a digital output. The A/D converter may be embedded in the processor 170, or may be provided as a separate component external to the processor 170. By monitoring the output of the directional coupler 240, the processor 170 may analyze characteristics (e.g., current, voltage, power, phase, and/or frequency) of the transmitted RF signal and characteristics (e.g., current, voltage, power, phase, and/or frequency) of the reflected electromagnetic waves.

Based on the characteristics of the transmitted RF signal, the processor 170 may determine whether the operation of the source unit 20 is being performed as intended. In addition, the characteristics of the transmitted RF signal may be used in conjunction with the characteristics of the reflected electromagnetic waves to determine the heating efficiency of the source unit 20 or the radiating unit 30. The processor 170 may control the source unit 20 such that the heating efficiency of the source unit 20 or the radiating unit 30 is maximized. For example, the processor 170 may adjust the frequency of the RF signal generated by the RF signal generation circuit 210 such that the power of the reflected electromagnetic waves is minimized. Minimizing the power of the reflected electromagnetic waves may mean that the frequency of the RF signal approaches the resonance condition of the insertion space. The characteristics of the transmitted RF signal may provide a criterion for whether the power of the reflected electromagnetic waves is minimized.

Since resonance of the electromagnetic waves in the insertion space may occur depending on the frequency of the RF signal, the insertion space may be referred to as a resonance unit. At least a part of the insertion space may be surrounded by at least one shielding member to prevent electromagnetic waves from leaking out of the aerosol-generating device 1. In accordance with an embodiment, the insertion space may further include a physical structure for ensuring that resonance occurs within a range controllable by the processor 170. The physical structure may include at least one conductor, and the resonance condition of the insertion space may vary depending on the placement, thickness, and length of the conductor. In addition, the physical structure may include a space for receiving a dielectric with low electromagnetic wave absorbance, independent of the dielectric contained in the aerosol-generating article. The dielectric with low electromagnetic wave absorbance may change the resonant frequency of the entirety of the resonance unit without absorbing energy that must be transmitted to an object to be heated. Accordingly, the resonance condition may be determined to be within a range controllable by the processor 170 even as the resonance unit is miniaturized.

The temperature sensing circuit 250 may be disposed in contact with or adjacent to the components included in the source unit 20 to measure the temperature of the source unit 20. For example, the temperature sensing circuit 250 may be disposed in contact with or adjacent to at least one of the RF signal generation circuit 210, the drive amplifier 220, and the power amplifier 230. In the process of generating and/or amplifying the RF signal, heat may be generated due to limited efficiency, and if excessive, the heat may adversely affect the components included in the source unit 20 or the other components included in the aerosol-generating device 1. The temperature measured by the temperature sensing circuit 250 may be used to prevent the source unit 20 from overheating.

The processor 170 may receive the measured temperature (or a value corresponding to the temperature) from the temperature sensing circuit 250 and may interrupt the operation of the source unit 20 upon determining that the source unit 20 is overheating. For example, the processor 170 may interrupt the operation of the source unit 20 by interrupting the supply of power to the source unit 20 or by sending a control signal. Hereinafter, the term “the supply of power to the source unit 20” will be used to mean controlling whether the source unit 20 operates.

The temperature sensing circuit 250 may include at least one of a thermocouple, a resistance temperature detector (RTD), a thermistor, a semiconductor temperature sensor, and an optical temperature sensor. In an example, the temperature sensing circuit 250 may be implemented as a chip-type sensor (e.g., a negative temperature coefficient (NTC) sensor) to minimize the area occupied thereby, but the present disclosure is not necessarily limited thereto.

Meanwhile, the aerosol-generating device 1 may further include other components in addition to the components shown in FIG. 1. For example, the aerosol-generating device 1 may further include a sensor unit, an output unit, an input unit, a communication unit, and a memory. Also, if the aerosol-generating device 1 is a hybrid type device that uses both an aerosol-generating article and a cartridge, the aerosol-generating device 1 may further include a cartridge heater. The cartridge heater may receive power from the power source 130 to heat a medium and/or aerosol-generating substance in the cartridge.

In accordance with an embodiment, the sensor unit may sense the state of the aerosol-generating device 1 or the state in the vicinity of the aerosol-generating device 1 and transmit sensed information to the processor 170. For example, the sensor unit may include a temperature sensor, a puff sensor, an insertion detection sensor, a reuse detection sensor, an overmoisture detection sensor, a cigarette identification sensor, a cartridge detection sensor, a cap detection sensor, and/or a motion detection sensor. Meanwhile, the sensor unit may further include various sensors, such as a liquid level sensor for detecting a liquid level in the cartridge and a flood sensor for detecting flooding of the aerosol-generating device 1.

In accordance with an embodiment, the temperature sensor may detect the temperature of the insertion space or the aerosol-generating article. The temperature sensor may be disposed in contact with or adjacent to the insertion space or the aerosol-generating article to directly measure the temperature of the insertion space or the aerosol-generating article. Alternatively, the temperature sensor may be disposed spaced apart from the insertion space or the aerosol-generating article to indirectly (e.g., contactlessly) measure the temperature of the insertion space or the aerosol-generating article. In an example, the temperature sensor may include an optical temperature sensor (e.g., an infrared temperature sensor).

In accordance with an embodiment, the temperature sensor may sense the temperature of the power source 130. The temperature sensor may be disposed adjacent to the power source 130. For example, the temperature sensor may be attached to one surface of the power source 130 (e.g., a battery), and/or mounted on one surface of a printed circuit board. In an example, the aerosol-generating device 1 may include a protection circuit module (PCM), and the temperature sensor may be disposed adjacent to the power source 130 along with the protection circuit module.

In accordance with an embodiment, the temperature sensor may be disposed in a housing (not shown) of the aerosol-generating device 1 to sense the temperature in the housing (not shown).

In accordance with an embodiment, the puff sensor may detect a user's puff.

In an example, the puff sensor may include a pressure sensor. The pressure sensor may output a signal corresponding to the internal pressure of the aerosol-generating device 1, and the processor 170 may detect the user's puff based on the signal corresponding to the internal pressure. Here, the internal pressure of the aerosol-generating device 1 may correspond to the pressure of an airflow path in which gas flows. The puff sensor may be disposed in the aerosol-generating device 1 so as to correspond to the airflow path in which the gas flows.

In another example, the puff sensor may include a temperature sensor. When a user puffs, a temporary temperature drop may occur in the airflow path, the insertion space, and the aerosol-generating article. The processor 170 may detect the user's puff based on a signal corresponding to the temperature of the airflow path output from the temperature sensor.

In another example, the puff sensor may include both a pressure sensor and a temperature sensor. In this case, the temperature sensor may measure a temperature that is used to calibrate the internal pressure measured by the pressure sensor. In an example, the puff sensor may calibrate a signal corresponding to the internal pressure based on the temperature measured by the temperature sensor and output the calibrated signal. In another example, the puff sensor may output a signal corresponding to the temperature measured by the temperature sensor and a signal corresponding to the internal pressure measured by the puff sensor. In this case, the processor 170 may receive the signals and calibrate the signal corresponding to the internal pressure based on the signal corresponding to the temperature.

In another example, the puff sensor may include a capacitive sensor. In the present disclosure, the capacitive sensor may also be referred to as a cap sensor or a capacitance sensor. When the user puffs, a temperature change and/or the flow of the aerosol in the insertion space may occur, whereby the dielectric constant in the insertion space may change. The processor 170 may detect the user's puff based on a signal corresponding to the dielectric constant of the insertion space output from the capacitive sensor.

The puff sensor is not limited to the examples described above and may be implemented as a variety of sensors for detecting the user's puff.

In accordance with an embodiment, the insertion detection sensor may detect insertion and/or removal of the aerosol-generating article. The insertion detection sensors may be installed in the vicinity of the insertion space.

In an example, the insertion detection sensor may include a capacitive sensor. The capacitive sensor may include at least one conductor, wherein the at least one conductor may be disposed adjacent to the insertion space. When the aerosol-generating article is inserted into or removed from the insertion space, the dielectric constant around the conductor may change. The processor 170 may detect the insertion and/or removal of the aerosol-generating article based on a signal corresponding to the dielectric constant in the insertion space output from the capacitive sensor.

In another example, the insertion detection sensor may include an inductive sensor. The inductive sensor may include at least one coil, wherein the at least one coil may be disposed adjacent to the insertion space. If the aerosol-generating article (e.g., a wrapper of the aerosol-generating article) includes a conductor, insertion or removal of the aerosol-generating article into or from the insertion space may cause a change in magnetic field around the coil in which the current flows. The processor 170 may detect the insertion and/or removal of the aerosol-generating article including the conductor based on the characteristics of the current output from or sensed by the inductive sensor (e.g., the frequency of the alternating current, current value, voltage value, inductance value, and impedance value). Alternatively, the aerosol-generating article (e.g., a medium unit of the aerosol-generating article) may include a susceptor (SUS). Even in this case, a change in magnetic field may occur around the coil based on the insertion or removal of the susceptor into or from the insertion space, and the processor 170 may detect the insertion and/or removal of the aerosol-generating article based on the characteristics of the current in the inductive sensor.

The insertion detection sensor is not limited to the examples described above and may be implemented as a variety of sensors (e.g., a proximity sensor) for detecting insertion and/or removal of the aerosol-generating article. In addition, the insertion detection sensor may include any combination of the above examples. In accordance with an embodiment, the insertion detection sensor may include a switch for detecting pressing by the aerosol-generating article.

In accordance with an embodiment, the reuse detection sensor may detect whether the aerosol-generating article is reused. In an example, the reuse detection sensor may be a color sensor for detecting the color of the aerosol-generating article. When the aerosol-generating article is used by the user, the generated aerosol or heating may cause a change in color of a part of the wrapper surrounding the outside of the aerosol-generating article. The color sensor may output a signal corresponding to optical characteristics (e.g., the wavelength of light) corresponding to the color of the wrapper based on light reflected from the wrapper. The processor 170 may determine that the aerosol-generating article inserted into the insertion space has already been used if a change in color of a part of the wrapper is detected.

In accordance with an embodiment, the overmoisture detection sensor may detect whether the aerosol-generating article is overmoisturized. For example, the overmoisture detection sensor may include a capacitive sensor. The capacitive sensor may include at least one conductor disposed adjacent to the insertion space. The processor 170 may detect whether the aerosol-generating article is overmoisturized based on the level of a signal corresponding to the dielectric constant output from the capacitive sensor. In an example, the processor 170 may determine a level range within which the level of the signal is included based on the look-up table, and determine the amount of moisture in the aerosol-generating article based on the determined level range.

In accordance with an embodiment, the cigarette identification sensor may detect whether the aerosol-generating article is authentic, and/or detect the type of aerosol-generating article.

In an example, the cigarette identification sensor may include an optical sensor for detecting an identification substance (or an identification mark) located on an outer surface (e.g., the wrapper) of the aerosol-generating article. The optical sensor may radiate light toward the identification substance (or the identification mark) on the aerosol-generating article and detect the authenticity and/or type of the aerosol-generating article based on the reflected light. For example, the identification substance may include a substance that emits light having a specific wavelength band based on the radiated light. Based on the wavelength band, the processor 170 may detect the authenticity and/or type of the aerosol-generating article.

In another example, the cigarette identification sensor may include a capacitive sensor. Depending on the type of aerosol-generating article inserted into the insertion space, the dielectric constant in the insertion space may vary. The processor 170 may detect the authenticity and/or type of the aerosol-generating article based on a signal corresponding to the dielectric constant in the insertion space output from the capacitive sensor.

In another example, the cigarette identification sensor may include an inductive sensor. If the wrapper and/or the inside (e.g., the medium unit) of the aerosol-generating article inserted into the insertion space includes a conductor, the characteristics of the current sensed by the inductive sensor (e.g., the frequency of alternating current, current value, voltage value, inductance value, and impedance value) may vary when the aerosol-generating article is inserted into the insertion space depending on the type of aerosol-generating article inserted into the insertion space. Based on the characteristics of the current output from the inductive sensor or sensed by the inductive sensor, the processor 170 may detect the authenticity and/or type of the inserted aerosol-generating article.

The cigarette identification sensor is not limited to the examples described above and may be implemented as a variety of sensors for sensing the authenticity of the aerosol-generating article and/or sensing the type of aerosol-generating article. In addition, the cigarette identification sensor may include any combination of the above examples.

In accordance with an embodiment, the cartridge detection sensor may detect the insertion and/or removal of the cartridge. For example, the cartridge detection sensor may include an inductive sensor, a capacitive sensor, a resistance sensor, a Hall sensor (a Hall IC), and/or an optical sensor.

In accordance with an embodiment, the cap detection sensor can detect mounting and/or removal of a cap. For example, the cap detection sensor may include an inductive sensor, a capacitive sensor, a resistance sensor, a contact sensor, a Hall sensor (a Hall IC), and/or an optical sensor. The cap may include a structure that covers at least a part of the cartridge mounted or inserted into the aerosol-generating device 1 or that covers at least a part of the housing of the aerosol-generating device 1. The cap detection sensor may output a signal corresponding to mounting or removal when the cap is mounted to or removed from the housing, and the processor 170 may detect mounting or removal of the cap based on a signal corresponding to mounting or removal.

In accordance with an embodiment, the motion detection sensor may detect the motion of the aerosol-generating device 1. The motion detection sensor may be implemented as at least one of an acceleration sensor or a gyro sensor.

In accordance with an embodiment, the sensor unit may further include at least one of a humidity sensor, a barometric pressure sensor, a magnetic sensor, a position sensor (a global positioning system (GPS) sensor), or a proximity sensor in addition to the aforementioned sensors. The function of each sensor may be intuitively deduced by those skilled in the art from the designation thereof, and thus a detailed description thereof will be omitted.

In accordance with an embodiment, the output unit may output information about the state of the aerosol-generating device 1. The output unit may include, but is not limited to, a display, a haptic portion, and/or an acoustic output portion. For example, information about the aerosol-generating device 1 may include the charging/discharging state of the power source 130 of the aerosol-generating device 1, the operational state of the source unit 20 or the radiating unit 30, the insertion/removal state of the aerosol-generating article and/or the cartridge, the mounting and/or removal state of the cap, or the state in which the use of the aerosol-generating device 1 is restricted (e.g., detection of an abnormal article). The display may visually provide information about the state of the aerosol-generating device 1 to the user. For example, the display may include a light emitting diode (LED), a liquid crystal display (LCD), or an organic light emitting diode (OLED). The display may be used as an input unit if the display includes a touch pad. The haptic portion may tactually provide information about the state of the aerosol-generating device 1 to the user. For example, the haptic portion may include a vibration motor, a piezoelectric element, or an electrical stimulation device. The acoustic output portion may audibly provide information about the aerosol-generating device 1 to the user. For example, the acoustic output portion may convert an electrical signal into an acoustic signal and output the same to the outside.

In accordance with an embodiment, the input unit may receive information input by the user. For example, the input unit may include a touch panel, a button, a keypad, a dome switch, a jog wheel, or a jog switch.

In accordance with an embodiment, the memory is hardware for storing various data processed in the aerosol-generating device 1, and may store data processed and to be processed by the processor 170. For example, the memory may include at least one of a flash memory type memory, a hard disk type memory, a multimedia card micro type memory, a card type memory (e.g., an SD or XD memory), a random access memory (RAM), a static random access memory (SRAM), a read-only memory (ROM), an electrically erasable programmable read-only memory (EEPROM), a programmable read-only memory (PROM), a magnetic memory, a magnetic disk, or an optical disc. For example, the memory may store data about the operating time of the aerosol-generating device 1, the maximum number of puffs, the current number of puffs, at least one temperature profile, and a user's smoking pattern.

In accordance with an embodiment, the communication unit may include at least one component for communication with other electronic devices (e.g., a portable electronic device). For example, the communication unit may include a Bluetooth communication unit, a Bluetooth low energy (BLE) communication unit, a near field communication unit, a wireless local area network (WLAN) communication unit, a ZigBee communication unit, an infrared data association (IrDA) communication unit, a Wi-Fi Direct (WFD) communication unit, an ultra-wideband (UWB) communication unit, an adaptive network topology (ANT)+ communication unit, a cellular network communication unit, an Internet communication unit, or a computer network (e.g., LAN or WAN) communication unit.

In accordance with an embodiment, the processor 170 may control the temperature of the insertion space or the aerosol-generating article by controlling the amplification rate of the source unit 20 (e.g., the power amplifier 230). The processor 170 may control the amplification rate of the source unit 20 (e.g., the power amplifier 230) based on the temperature of the insertion space or the aerosol-generating article sensed using the temperature sensor. The processor 170 may control the amplification rate of the source unit 20 (e.g., the power amplifier 230) based on a temperature profile and/or a power profile stored in the memory.

In addition, the processor 170 may control the temperature of the cartridge heater by controlling the supply of power from the power source 130 to the cartridge heater. The processor 170 may control the temperature of the cartridge heater and/or the power supplied to the cartridge heater based on the temperature of the cartridge heater sensed using the temperature sensor. The processor 170 may control the temperature of the cartridge heater and/or the power supplied to the cartridge heater based on the temperature profile and/or the power profile stored in the memory.

In accordance with an embodiment, the processor 170 may prevent the insertion space, the aerosol-generating article, and/or the cartridge heater from overheating. For example, the processor 170 may control the operation of the power conversion circuit to reduce the amount of power supplied to the source unit 20 or the cartridge heater, or to stop supply of power to the source unit 20 or the cartridge heater based on the temperature of the insertion space, the aerosol-generating article, and/or the cartridge heater exceeding a predetermined limit temperature.

In accordance with an embodiment, the processor 170 may control the supply of power to the source unit 20 or the cartridge heater based on the result sensed by the sensor unit.

In accordance with an embodiment, the processor 170 may control the supply of power to the source unit 20 or the cartridge heater based on the insertion and/or removal of the aerosol-generating article into and/or from the insertion space. For example, the processor 170 may perform control such that power is supplied to the source unit 20 or the cartridge heater upon determining that the aerosol-generating article has been inserted into the insertion space using the insertion detection sensor. The processor 170 may interrupt the supply of power to the source unit 20 or the cartridge heater upon determining that the aerosol-generating article has been removed from the insertion space using the insertion detection sensor. If the temperature of the insertion space or the aerosol-generating article is equal to or greater than the limit temperature or if the change slope of the temperature of the insertion space or the aerosol-generating article is equal to or greater than a set slope, the processor 170 may determine that the aerosol-generating article has been removed from the insertion space.

In accordance with an embodiment, the processor 170 may control the supply time and/or supply amount of power to the source unit 20 or the cartridge heater based on the state of the aerosol-generating article. For example, the processor 170 may increase the supply time of power (e.g., warm-up time) to the source unit 20 or the cartridge heater upon determining that the aerosol-generating article is overmoisturized using the overmoisture detection sensor.

In accordance with an embodiment, the processor 170 may control the supply of power to the source unit 20 or the cartridge heater based on whether the aerosol-generating article is to be reused. For example, the processor 170 may interrupt the supply of power to the source unit 20 or the cartridge heater upon determining that the aerosol-generating article has been used.

In accordance with an embodiment, the processor 170 may control the supply of power to the source unit 20 or the cartridge heater based on coupling and/or removal of the cartridge. For example, the processor 170 may stop the supply of power to the source unit 20 or the cartridge heater, or may perform control such that no power is supplied to the source unit 20 or the cartridge heater, upon determining that the cartridge has been removed using the cartridge detection sensor.

In accordance with an embodiment, the processor 170 may control the supply of power to the source unit 20 or the cartridge heater based on whether the aerosol-generating substance in the cartridge is exhausted. For example, the processor 170 may determine that the aerosol-generating substance in the cartridge has been exhausted upon determining that the temperature of the cartridge heater exceeds the limit temperature while the cartridge heater is warming up (i.e., during a warm-up period). Upon determining that the aerosol-generating substance in the cartridge has been exhausted, the processor 170 may interrupt the supply of power to the source 20 or the cartridge heater.

In accordance with an embodiment, the processor 170 may control the supply of power to the source unit 20 or the cartridge heater based on the availability of the cartridge. For example, the processor 170 may determine that the cartridge is unavailable upon determining that the current number of puffs is equal to or greater than the maximum number of puffs set for the cartridge based on data stored in the memory. Alternatively, the processor 170 may determine that the cartridge is unavailable if the total time the cartridge heater has been heated is equal to or greater than a preset maximum time or the total amount of power supplied to the cartridge heater is equal to or greater than a preset maximum amount of power. In this case, the processor 170 may stop the supply of power to the source unit 20 or the cartridge heater, or may perform control such that no power is supplied to the source unit 20 or the cartridge heater.

In accordance with an embodiment, the processor 170 may control the supply of power to the source unit 20 or the cartridge heater based on the user's puff. For example, the processor 170 may determine whether a puff has occurred and/or the intensity of the puff using the puff sensor. The processor 170 may interrupt the supply of power to the source unit 20 or the cartridge heater when the number of puffs reaches a preset maximum number of puffs and/or when no puffs are sensed for a preset period of time. The processor 170 may control the supply of power to the source unit 20 or the cartridge heater when a puff is detected.

In accordance with an embodiment, the processor 170 may control the supply of power to the source unit 20 or the cartridge heater based on the authenticity and/or type of the aerosol-generating article (or, the cartridge). For example, the processor 170 may detect the authenticity and/or type of the aerosol-generating article using the cigarette identification sensor. In an example, the processor 170 may interrupt the supply of power to the source unit 20 or the cartridge heater if the aerosol-generating article (or the cartridge) is detected to be counterfeit. The processor 170 may control (e.g., initiate) the supply of power to the source unit 20 or the cartridge heater if the aerosol-generating article (or the cartridge) is detected to be genuine. In another example, the processor 170 may control the supply of power to the source unit 20 or the cartridge heater differently depending on the type of the aerosol-generating article (or the cartridge). More specifically, the processor 170 may control the amplification rate of the source unit 20 or the temperature and/or power of the cartridge heater based on a first temperature profile (or a first power profile) if the aerosol-generating article (or the cartridge) is detected to be a first aerosol-generating article (or a first cartridge), and may control the amplification rate of the source unit 20 or the temperature and/or power of the cartridge heater based on a second temperature profile (or a second power profile) if the aerosol-generating article (or the cartridge) is detected to be a second aerosol-generating article (or a second cartridge).

In accordance with an embodiment, the processor 170 may control the output unit based on the result sensed by the sensor unit. For example, the processor 170 may control the output unit to visually, tactually, and/or audibly provide information that the aerosol-generating device 1 is about to shut down when the number of puffs counted using the puff sensor reaches a preset number. For example, the processor 170 may control the output unit to visually, tactually, and/or audibly provide information about the temperature of the insertion space, the aerosol-generating article, or the cartridge heater.

In accordance with an embodiment, the processor 170 may store and update the history of a predetermined event in the memory based on the occurrence of the event. For example, the event may include an operation performed by the aerosol-generating device 1, such as detecting insertion of the aerosol-generating article, initiating heating of the aerosol-generating article, detecting puffing, terminating puffing, detecting overheating, detecting application of overvoltage to the cartridge heater, terminating heating of the aerosol-generating article, turning on/off the aerosol-generating device 1, initiating charging of the power source 130, detecting overcharging of the power source 130, or terminating charging of the power source 130. For example, the history of the event may include the date when the event occurred or log data corresponding to the event. For example, if the predetermined event is detection of insertion of an aerosol-generating article, the log data corresponding to the event may include data about a sensing value of the insertion detection sensor. For example, if the predetermined event is detection of overheating of the cartridge heater, the log data corresponding to the event may include data about the temperature of the cartridge heater, the voltage applied to the cartridge heater, or the current flowing in the cartridge heater.

In accordance with an embodiment, the processor 170 may control the communication unit to form a communication link with an external device, such as a mobile terminal of the user.

In accordance with an embodiment, the processor 170 may lift a restriction on the use of at least one function (e.g., a heating function) of the aerosol-generating device 1 upon receiving data regarding authentication from the external device via the communication link. For example, the data regarding the authentication may include user's birthday, a unique number indicative of the user, or whether the user has completed authentication.

In accordance with an embodiment, the processor 170 may transmit data about the state of the aerosol-generating device 1 (e.g., the remaining capacity of the power source 130 or the operation mode) to the external device via the communication link. The transmitted data may be output through a display of the external device.

In accordance with an embodiment, upon receiving a request to search for the location of the aerosol-generating device 1 from the external device via the communication link, the processor 170 may control the output unit to perform an operation corresponding to the location search. For example, the processor 170 may control the haptic portion to generate vibration, or may control the display to output an object corresponding to the location search and the search termination.

In accordance with an embodiment, the processor 170 may perform firmware update upon receiving firmware data from the external device via the communication link.

In accordance with an embodiment, the processor 170 may transmit data about a sensing value of at least one sensor unit to an external server (not shown) via the communication link, and may receive and store a learning model generated by learning the sensing value through machine learning, such as deep learning, from the server. The processor 170 may perform an operation such as determining a user's inhalation pattern or generating a temperature profile using the learning model received from the server.

Although not shown in FIG. 1, the aerosol-generating device 1 may further include a protection circuit module. The protection circuit module may include at least one switching element and may block a path to the power source 130 in response to overcharging and/or overdischarging of the power source 130.

The aerosol-generating article mentioned in the present disclosure may include at least one aerosol-generating rod (e.g., a medium portion) and at least one filter rod. The radiating unit 30 may be disposed so as to correspond to the at least one aerosol-generating rod, and may be designed differently depending on the arrangement order and/or position of the aerosol-generating rod and the filter rod. The aerosol-generating rod may include at least one of nicotine, an aerosol-generating substance, and an additive. For example, the aerosol-generating substance may include glycerin (e.g., vegetable glycerin (VG)) and/or propylene glycol (PG), and may include various other substances. For example, the additive may include a flavoring agent and/or an organic acid, and may include various other substances. For example, the aerosol-generating rod may include an aerosol-generating substrate (e.g., a sheet) impregnated with a non-tobacco substance (e.g., an aerosol-generating substance and/or nicotine) in a liquid state, and/or a tobacco substance (e.g., tobacco leaf or reconstituted tobacco) in a solid state. The tobacco substance may be included in the aerosol-generating rod in various forms, such as cut tobacco, granule, or powder. In accordance with an embodiment, the additive of the aerosol-generating rod may include a basic substance. Based on the basic substance, the nicotine of the tobacco substance included in the aerosol-generating rod may have a basic pH (e.g., pH 7.0 or higher). In this case, freebase nicotine may be emitted from the aerosol-generating rod even at low temperatures. In accordance with an embodiment, the aerosol-generating rod may include two or more aerosol-generating rods, wherein each of the two or more aerosol-generating rods may include a tobacco substance and/or a non-tobacco substance. Meanwhile, although not shown, the at least one aerosol-generating rod and the at least one filter rod may individually and/or collectively be wrapped by at least one wrapper. In the present disclosure, the aerosol-generating article may be referred to as a stick.

The cartridge mentioned in the present disclosure may contain an aerosol-generating substance in one of a liquid state, a solid state, a gaseous state, or a gel state. The aerosol-generating substance may include a liquid composition. For example, the liquid composition may be a liquid including a tobacco-containing substance, including a volatile tobacco flavor component, or may be a liquid including a non-tobacco substance. Meanwhile, the cartridge may include a reservoir including the aerosol-generating substance and/or a liquid delivery means impregnated with (containing) the aerosol-generating substance. For example, the liquid delivery means may include a wick, such as a cotton fiber, ceramic fiber, glass fiber, or porous ceramic. The cartridge heater may be included in a cartridge in a coil-shaped structure surrounding (or winding) the liquid delivery means or in contact with one side of the liquid delivery means. Alternatively, the cartridge heater may be included in the aerosol-generating device 1, which is separable from the cartridge.

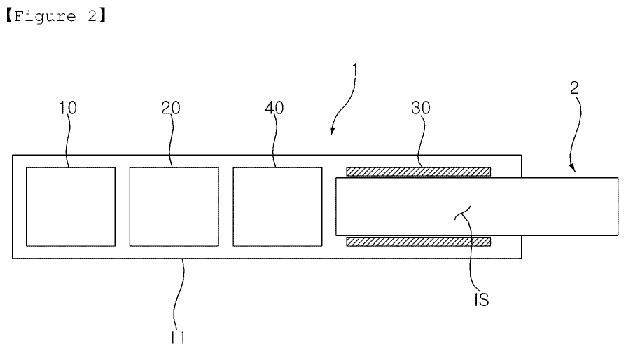

FIG. 2 illustrates the aerosol-generating device 1 according to an embodiment of the present disclosure.

According to the embodiment, the aerosol-generating device 1 may include a housing 11, a controller 10, a source unit 20, a radiating unit 30, and an antenna adjuster 40. However, those skilled in the art will understand that components included in the aerosol-generating device 1 are not limited to those illustrated in FIG. 2, and that some of the components may be omitted or new configurations may be added. The aerosol-generating device 1 illustrated in FIG. 2 may be referred to as an “external heating type” aerosol-generating device that heats the outside of an aerosol-generating article 2. In the drawings below, any description overlapping with FIG. 2 will be omitted.

According to an embodiment, the housing 11 may provide a space opened upwardly for the aerosol-generating article 2 to be inserted. In the present disclosure, the space opened upwardly may be referred to as an insertion space IS. The insertion space IS may be formed by being caved in the interior of the housing 11 to a predetermined depth so that at least a portion of the aerosol-generating article 2 may be inserted. The depth of the insertion space IS may be greater than a length of a region in the aerosol-generating article 2 that includes an aerosol-generating material and/or medium. A lower end of the aerosol-generating article 2 may be inserted into the interior of the housing 11, and an upper end of the aerosol-generating article 2 may protrude to the outside of the housing 11. A user may bite the upper end of the aerosol-generating article 2 exposed to the outside and inhale aerosol.

According to an embodiment, the radiating unit 30 may heat the aerosol-generating article 2. Referring to FIG. 2, the radiating unit 30 may be an external heating structure.

According to an embodiment, the radiating unit 30 may extend upwardly around the insertion space IS into which the aerosol-generating article 2 is inserted. For example, the radiating unit 30 may be arranged to surround at least a portion of the insertion space IS. For example, the radiating unit 30 may include a tube shape (e.g., a cylindrical shape) having a hollow inside. The radiating unit 30 may include a shape having a hollow inside and surrounding the hollow. The radiating unit 30 may be arranged to surround at least a portion of the insertion space IS. The radiating unit 30 may heat the outside of the aerosol-generating article 2 inserted into the hollow.

According to an embodiment, the radiating unit 30 may include a dielectric heating type heater. The aerosol-generating device 1 may include a tube-shaped antenna surrounding the insertion space IS. Meanwhile, an insulating material may be placed on the outside of the radiating unit 30. In this way, heat radiated in a radially outer direction from the radiating unit 30 and applied to the outside of the housing 11 may be reduced.

According to an embodiment, the radiating unit 30 may include heating elements, and a first antenna and a second antenna may be arranged side by side in a length direction to surround at least a portion of the insertion space IS. The first antenna and the second antenna may operate as a dielectric heating type heater, and may sequentially or simultaneously radiate electromagnetic waves.

Unlike that illustrated in FIG. 2, the antenna of the radiating unit 30 may be wound around a rod-shaped or needle-shaped structure and inserted into the aerosol-generating article 2 through a lower part of the aerosol-generating article 2. In this case, the electromagnetic waves radiated from the antenna may propagate from the inside to the outside of the aerosol-generating article 2 to heat the aerosol-generating article 2.

According to an embodiment, the antenna adjuster 40 may adjust a length and/or a shape of the antenna of the radiating unit 30.

According to an embodiment, the aerosol-generating device 1 may be provided with an airflow channel in which air flows. For example, the housing 11 may include a structure (e.g., a hole) through which air may be introduced into the housing 11 from the outside. The air introduced into the housing 11 may enter the aerosol-generating article 2 through the lower end (i.e., an upstream side) of the aerosol-generating article 2. An aerosol generated by heating of the aerosol-generating article 2 may be inhaled into an oral cavity of the user through the upper end (i.e., a downstream side) of the aerosol-generating article 2 together with the introduced air.

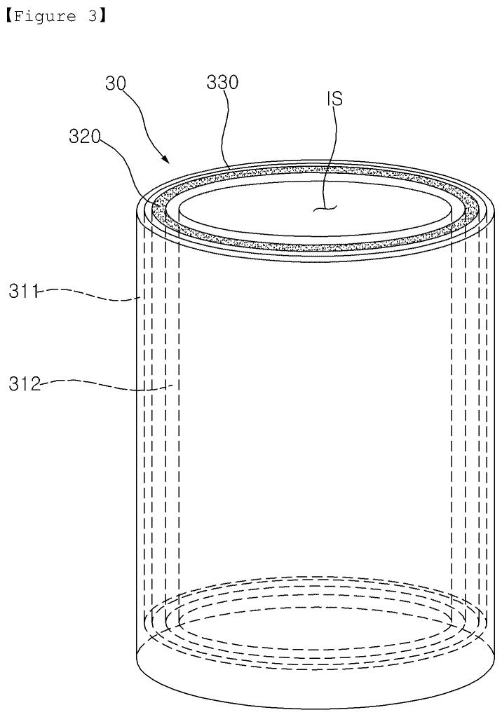

FIG. 3 is a drawing illustrating the radiating unit according to an embodiment of the present disclosure.

Referring to FIG. 3, the radiating unit 30 may be disposed in a body 11 (e.g., a housing 11). The radiating unit 30 may be referred to as a heater assembly. The radiating unit 30 may have a tubular or cylindrical shape including a hollow therein. The radiating unit 30 may provide the insertion space IS therein. The radiating unit 30 may heat the aerosol-generating article 2 inserted into the insertion space IS.

The radiating unit 30 may include antenna housings 311 and 312 and an antenna 320. The antenna housings 311 and 312 may each have a hollow cylinder shape with one side open. An inner wall 312 of the antenna housing may form the insertion space IS therein. An outer wall 311 of the antenna housing may surround an outer side of the inner wall 312 and form an outer surface of the antenna housing. The outer wall 311 may receive a shielding material 330 therein. The shielding material 330 may surround the outer side of the inner wall 312 along the outer wall. The shielding material 330 may include a metal material. For example, the shielding material 330 may be a metal sheet or a metal mesh. The shielding material 330 may be referred to as a shielding portion.

An antenna receiving space may be formed between the outer wall 311 and the inner wall 312.

The antenna 320 may be received in the antenna receiving space. The antenna 320 may be a structure in which a thin film-shaped track forming the antenna is rolled up or a spiral track structure. The antenna 320 is arranged adjacent to the insertion space IS and may radiate microwaves that dielectrically heat the aerosol-generating article 2 into the insertion space IS. The antenna 320 may radiate an RF signal generated by the source unit 20 (see FIGS. 1 and 2) into the insertion space IS as microwaves. Here, the microwaves may refer to electromagnetic waves having a frequency of 300 MHz to 300 GHz.

The length and the shape of the antenna 320 may be changed. The antenna 320 may be formed of an elastic material. For example, the antenna 320 may include an elastic metal material such as copper, iron, aluminum, chromium, or an alloy thereof (e.g., Kanthal). The antenna 320 may have some parts connected to the antenna adjuster 40 (see FIG. 2), and the length and the shape may be changed by an operation of the antenna adjuster 40.

A pair of brackets (not shown) may be attached or coupled to the radiating unit 30. The pair of brackets may be coupled with an opening at one end and an opening at the other end of the hollow radiating unit 30, respectively. The pair of brackets may be coupled with the radiating unit 30 to support the radiating unit 30.

A casing (not shown) may be attached or coupled to the radiating unit 30. The casing may surround an outer surface of the radiating unit 30. The casing and the bracket may be coupled with each other to receive the radiating unit 30 inside. Accordingly, the radiating unit 30 may be protected from the outside, and the radiating unit 30 may be firmly supported, thereby ensuring rigidity of the radiating unit 30.

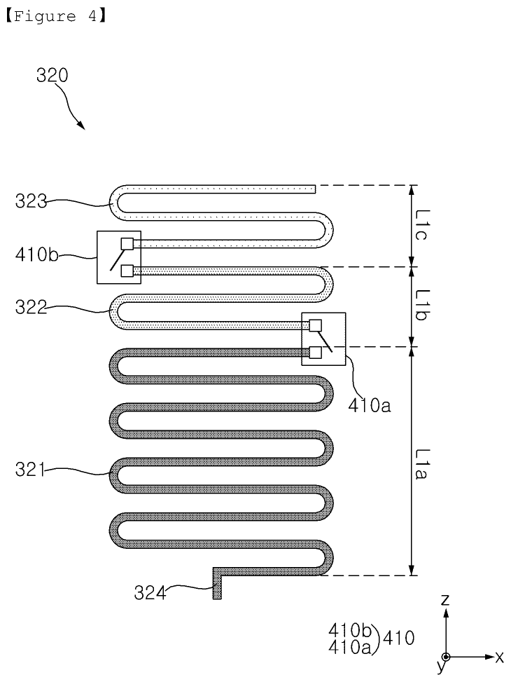

FIG. 4 is a drawing illustrating a track and a switch of the antenna according to an embodiment of the present disclosure. FIG. 4 illustrates the antenna 320 in a flatly unfolded state.

Referring to FIG. 4, the antenna 320 may have a structure in which a thin film-shaped track forming the antenna is rolled up. In a flatly unfolded state, the antenna 320 may have a meanderingly curved shape.

The antenna 320 may include a plurality of tracks. For example, the antenna 320 may include a first track 321 to a third track 323. The first track 321 to the third track 323 may extend in the same direction (e.g., in a z-direction) as a whole. Each track may include at least one bent portion and may have a meanderingly curved shape.

The first track 321 may have one end connected to a source connection portion 324. The source connection portion 324 may protrude outward from one side of the first track 321. The source connection portion 324 may be formed integrally with the first track 321. The source connection portion 324 may be connected to the source unit 20 and may receive an RF signal from the source unit 20.

A shape of the first track 321 may be a rectangle having a length L1a and a width. The first track 321 may have an overall rectangular shape in a state of being unfolded flat. The length L1a of the first track 321 may be defined as a distance between both ends of the first track 321 based on a direction in which the first track 321 extends (e.g., in the z-direction) when the antenna 320 is unfolded. The width of the first track 321 may be defined as a distance between both ends of the first track 321 based on a direction perpendicular to the direction in which the first track 321 extends (e.g., an x-direction) when the first track 321 is unfolded.

The second track 322 may be arranged adjacent to the first track 321. The second track 322 may be arranged parallel to the first track 321 in a longitudinal direction of the first track 321. A shape of the second track 322 may be a rectangle having a length L1b and a width. The length L1b of the second track 322 may be equal to or shorter than the length L1a of the first track 321.

The third track 323 may be arranged adjacent to the second track 322. The third track 323 may be arranged parallel to the first track 321 and the second track 322 in the longitudinal direction of the first track 321. A shape of the third track 323 may be a rectangle having a length L1c and a width. The length L1c of the third track 322 may be equal to or shorter than the length L1a of the first track 321.

A track switch 410 may be arranged between adjacent tracks. The track switch 410 may be referred to as an antenna adjuster. The track switch 410 may be arranged between each pair of adjacent tracks. For example, the track switch 410 may include a first track switch 410a arranged between the first track 321 and the second track 322 and a second track switch 410b arranged between the second track 322 and the third track 323.

The track switch 410 may selectively connect adjacent tracks. For example, the first track switch 410a may selectively connect the first track 321 and the second track 322 by an opening and closing operation. The second track switch 410b may selectively connect the second track 322 and the third track 323 by an opening and closing operation. The track switch 410 may include at least one of a single pole single throw (SPST) switch or a single pole double throw (SPDT) switch.

When the first track switch 410a is opened, the first track 321 and the second track 322 may be electrically separated, and when the first track switch 410a is closed, the first track 321 and the second track 322 may be electrically connected. When the first track 321 and the second track 322 are electrically connected, the first track 321 and the second track 322 may form a single long track. In other words, when the first track 321 and the second track 322 are electrically connected, the length of the antenna 320 may be extended by the length L1b of the second track 322.

When the second track switch 410b is opened, the second track 322 and the third track 323 may be electrically separated, and when the second track switch 410b is closed, the second track 322 and the second track 323 may be electrically connected. When the second track 322 and the third track 323 are electrically connected in a state in which the second track 322 is electrically connected to the first track 321, the first track 321, the second track 322, and the third track 323 may form a single long track. In other words, when the first track 321 to the third track 323 are electrically connected, the length of the antenna 320 may be extended by the length L1b of the second track 322 and the length L1c of the third track 323.

Accordingly, the length and the shape of the antenna 320 may be easily changed by the track switch 410 that selectively connects the respective tracks of the antenna 320.

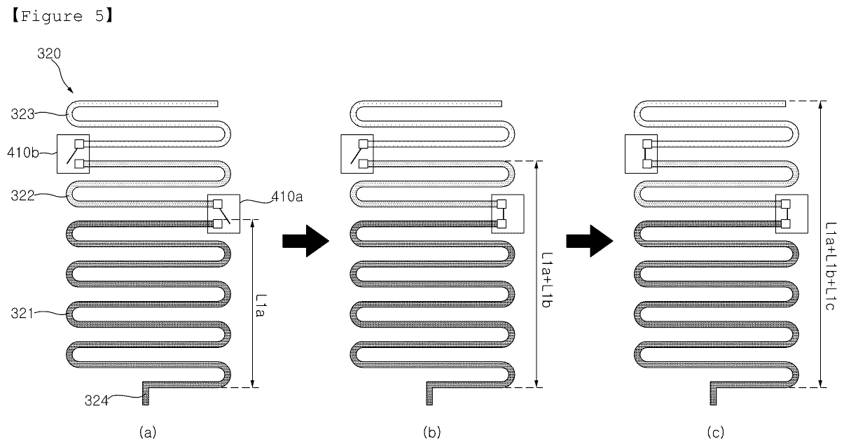

FIG. 5 is a drawing illustrating that the length and the shape of the antenna are changed by a switch operation according to an embodiment of the present disclosure.

Referring to FIG. 5, in a first case, the first track switch 410a may be opened ((a) of FIG. 5). In this case, the second track 322 and the third track 323 may be electrically separated from the first track 321. When an RF signal is received from the source unit 20 through the source connection portion 324, the first track 321 may operate as an antenna and microwaves may be radiated.

In a second case, the first track switch 410a may be closed and the second track switch 410b may be opened ((b) of FIG. 5). In this case, the second track 322 may be electrically connected to the first track 321, and the third track 323 may be electrically separated from the first track 321. When an RF signal is received from the source unit 20 through the source connection portion 324, the first track 321 and the second track 322 may operate as an integrated antenna and microwaves may be radiated.

In a third case, the first track switch 410a and the second track switch 410b may be closed ((c) of FIG. 5). In this case, the second track 322 and the third track 323 may be electrically connected to the first track 321. When an RF signal is received from the source unit 20 through the source connection portion 324, the first track 321, the second track 322, and the third track 323 may operate as a single antenna and microwaves may be radiated.

In each case, the length and the shape of the antenna radiating microwaves may be different. Even when the same RF signal is applied, microwaves of different frequencies may be radiated by antennas having different lengths and shapes.

In the first case, the antenna 320 has a first length Lla and may radiate microwaves having a first frequency. In the second case, the antenna 320 has a second length L1a+L1b, may have a shape with a larger bent area than the antenna of the first case, and may radiate microwaves having a second frequency different from the first frequency. In the third case, the antenna 320 has a third length L1a+L1b+L1c, may have a shape with a larger bent area than the antenna of the second case, and may radiate microwaves having a third frequency different from the second frequency.

Accordingly, the frequency radiated from the antenna 320 may be easily changed.

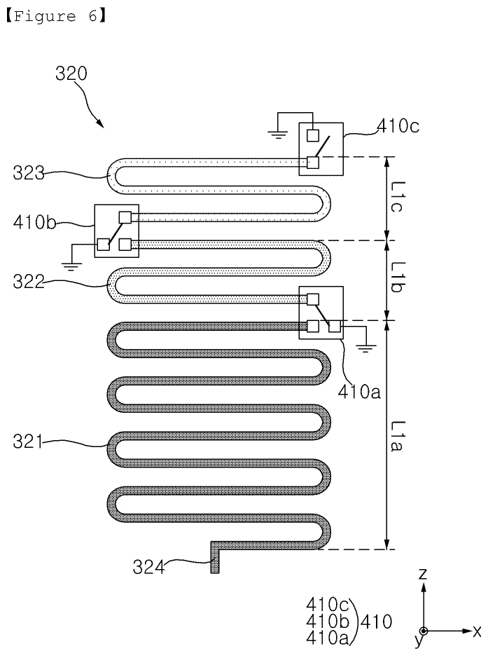

FIG. 6 is a drawing illustrating a track and a switch of an antenna according to an embodiment of the present disclosure. FIG. 6 illustrates the antenna 320 in a flatly unfolded state. A detailed description of a feature illustrated in FIG. 6 that overlaps with that of FIG. 4 and FIG. 5 will be omitted.

Referring to FIG. 6, the antenna 320 may include a plurality of tracks. For example, the antenna 320 may include a first track 321 to a third track 323.

A track switch 410 may be arranged at a location adjacent to each track. For example, the track switch 410 may include a first track switch 410a arranged between the first track 321 and the second track 322, a second track switch 410b arranged between the second track 322 and the third track 323, and a third track switch 410c arranged adjacent to the third track 323.

The first track switch 410a may selectively connect the first track 321 and the second track 322 by a switching operation. The second track switch 410b may selectively connect the second track 322 and the third track 323 by a switching operation. The third track switch 410c may ground the third track 323 or connect the third track 323 to a shielding material 330 by a switching operation. The first track switch 410a and the second track switch 410b may each include an SPDT switch. The third track switch 410c may include an SPST switch.

When the first track 321 and the second track 322 are electrically connected by the first track switch 410a, the first track 321 and the second track 322 may form a single long track.

When the second track 322 and the third track 323 are electrically connected by the second track switch 410b in a state in which the second track 322 is electrically connected to the first track 321, the first track 321, the second track 322, and the third track 323 may form a single long track.

Accordingly, the length and the shape of the antenna 320 may be easily changed by the track switch 410 that selectively connects the respective tracks of the antenna 320.

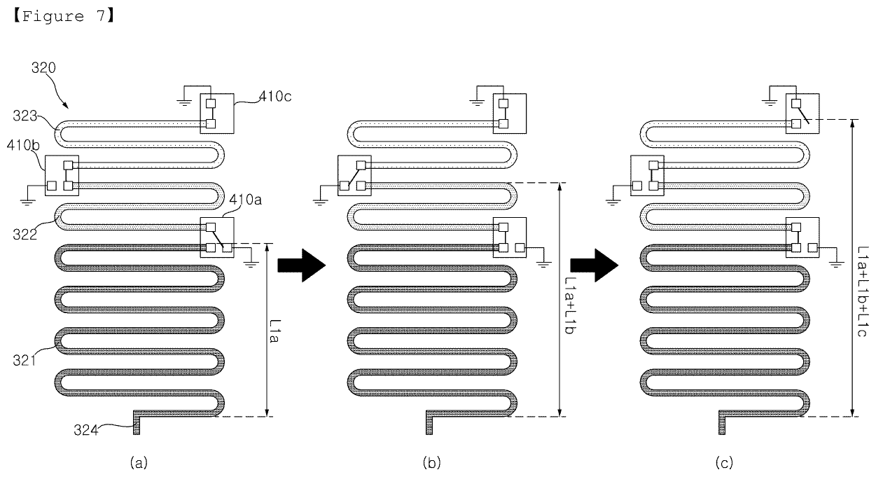

FIG. 7 is a drawing illustrating that the length and the shape of the antenna are changed by a switch operation according to an embodiment of the present disclosure.

Referring to FIG. 7, in a first case, the first track switch 410a may electrically separate the first track 321 and the second track 322 ((a) of FIG. 7). In this instance, the first track switch 410a may ground one end of the second track 322 or electrically connect the one end of the second track 322 to the shielding material 330. The second track switch 410b may electrically connect the other end of the second track 322 to one end of the third track 323. The third track switch 410c may ground the other end of the third track 323 or electrically connect the other end of the third track 323 to the shielding material 330.

By the switching operations of the first to third track switches 410a, 410b, and 410c, the second track 322 and the third track 323 may be electrically separated from the first track 321. In addition, the second track 323 and the third track 323 may be grounded or electrically connected to the shielding material 330.

When an RF signal is received from the source unit 20 through the source connection portion 324, the first track 321 may operate as an antenna to radiate microwaves. The second track 323 and the third track 323 may be grounded or electrically connected to the shielding material 330 to prevent the radiated microwaves from leaking outside a region where the antenna is arranged or a region surrounded by the antenna.

In a second case, the first track switch 410a may electrically connect the first track 321 and the second track 322 ((b) of FIG. 7). The second track switch 410b may electrically separate the other end of the second track 322 from one end of the third track 323. In this instance, the second track switch 410b may ground the one end of the third track 323 or electrically connect the one end of the third track 323 to the shielding material 330. The third track switch 410c may ground the other end of the third track 323 or electrically connect the other end of the third track 323 to the shielding material 330.

By the switching operations of the first to third track switches 410a, 410b, and 410c, the second track 322 may be electrically connected to the first track 321, and the third track 323 may be electrically separated from the first track 321. In addition, the third track 323 may be grounded or electrically connected to the shielding material 330.

When an RF signal is received from the source unit 20 through the source connection portion 324, the first track 321 and the second track 322 may operate as an integrated antenna and microwaves may be radiated. The third track 323 may be grounded or electrically connected to the shielding material 330, thereby preventing the radiated microwaves from leaking outside the region where the antenna is arranged or the region surrounded by the antenna.

In a third case, the first track switch 410a may electrically connect the first track 321 and the second track 322 ((c) of FIG. 7). The second track switch 410b may electrically connect the second track 322 and the third track 323. The third track switch 410c may be opened.

By the switching operations of the first to third track switches 410a, 410b, and 410c, the second track 322 and the third track 323 may be electrically connected to the first track 321.

When an RF signal is received from the source unit 20 through the source connection portion 324, the first track 321, the second track 322, and the third track 323 may operate as an integrated antenna and microwaves may be radiated.

Accordingly, the frequency radiated from the antenna 320 may be easily changed. In addition, the microwave radiated from the antenna may be prevented from leaking outside the region where the antenna is arranged or the region surrounded by the antenna due to tracks not operating as the antenna 320.

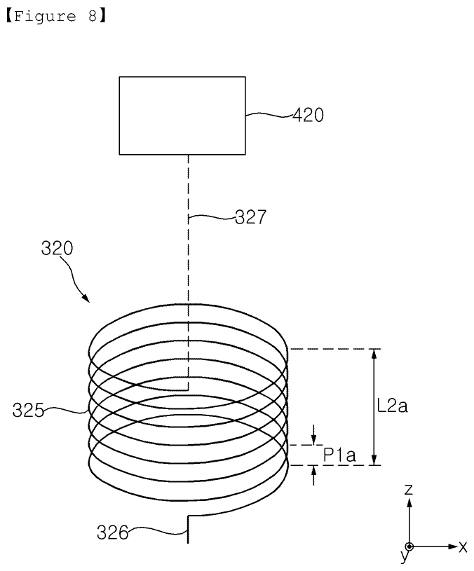

FIG. 8 is a drawing illustrating the antenna and a driver according to an embodiment of the present disclosure.

Referring to FIG. 8, the antenna 320 may have a helical structure. The antenna 320 may include a helical track 323 and a source connection portion 326.

The helical track 325 may have a shape in which an elongated line is helically wound to form a plurality of turns. One end of the helical track 325 may be connected to the source connection portion 326. The source connection portion 326 may protrude outward from one side of the helical track 325. The source connection portion 326 may be integrally formed with the helical track 325. The source connection portion 326 may be connected to the source unit 20 and may receive an RF signal from the source unit 20.

The other end of the helical track 325 may be connected to a driver 420. The driver 420 may be referred to as an antenna adjuster. A pulling connector 327 connecting the other end of the helical track 325 and the driver 420 may be formed of a dielectric having low microwave absorption.

The driver 420 may include a means such as a motor that rotates in a forward or reverse direction. When the driver 420 rotates in the forward direction, the other end of the helical track 325 may be moved in a longitudinal direction of the track (e.g., in a +z-direction) by the driver 420, and a length L2a and a pitch Pla of the helical track 325 may be increased. When the driver 420 rotates in the reverse direction, the other end of the helical track 325 may be moved in the longitudinal direction of the track (e.g., in a−z-direction) by the elastic restoring force of the track, and the length L2a and the pitch Pla of the helical track 325 may be reduced.

Accordingly, the length and the shape of the antenna 320 may be easily changed by the driver 420 connected to the antenna 320.

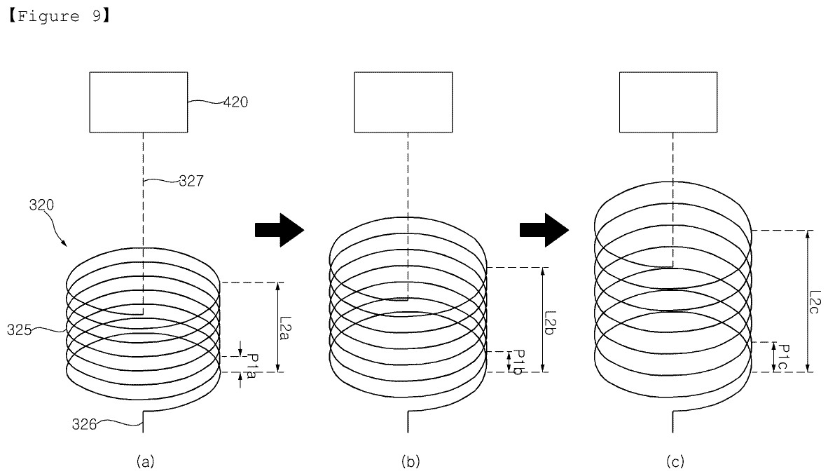

FIG. 9 is a drawing illustrating that the length and the shape of the antenna are changed by a driver operation according to an embodiment of the present disclosure.

Referring to FIG. 9, in a first case, the driver 420 may not operate ((a) of FIG. 9). In this case, the antenna 320 may have a first length L2a and a first pitch Pla. The antenna 320 may radiate microwaves having a fourth frequency.

In a second case, the driver 420 may rotate in one direction to move the other end of the helical track 325 in the longitudinal direction of the antenna 320 ((b) of FIG. 9). In this case, the antenna 320 may extend in the longitudinal direction. The antenna 320 may have a second length L2b longer than the first length L2a and a second pitch P1b longer than the first pitch Pla. The antenna 320 may radiate microwaves having a fifth frequency different from the fourth frequency.

In a third case, the driver 420 may rotate in one direction to move the other end of the helical track 325 further in the longitudinal direction of the antenna 320 ((c) of FIG. 9). In this case, the antenna 320 may be extended in the longitudinal direction. The antenna 320 may have a third length L2c longer than the second length L2b and a third pitch Plc longer than the second pitch P1b. The antenna 320 may radiate microwaves having a sixth frequency different from the fifth frequency.

In the second or the third case, when the driver 420 rotates in the other direction, the other end of the helical track 325 may move toward one end of the helical track 325 by the elastic restoring force of the track. In this case, the size of the antenna 320 may be reduced in the length direction, and a frequency of the microwaves radiated from the antenna 320 may be changed.

Accordingly, the frequency radiated from the antenna 320 may be easily changed.

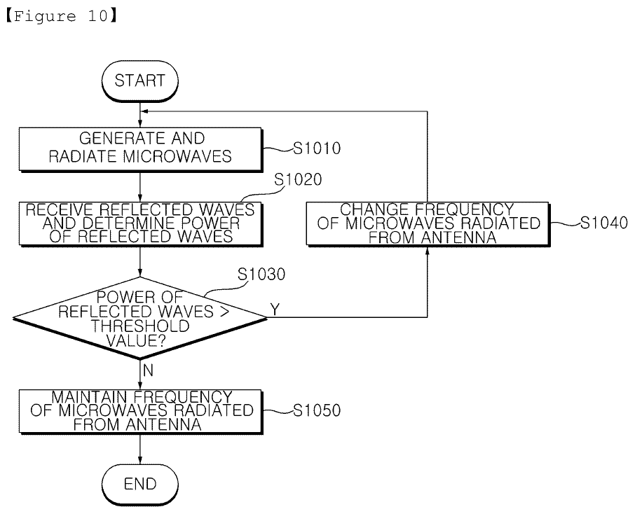

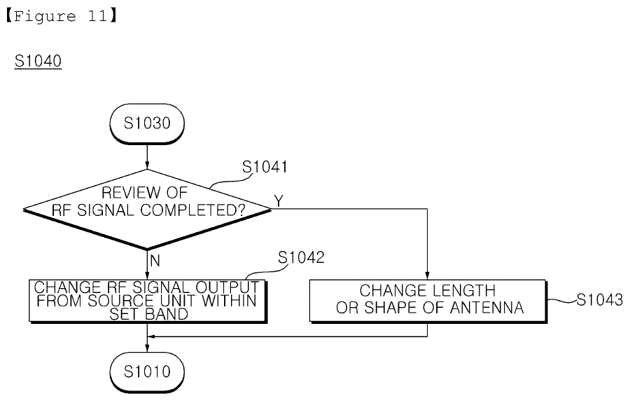

FIG. 10 and FIG. 11 are flowcharts illustrating microwave frequency change control according to an embodiment of the present disclosure. FIG. 11 illustrates a detailed process of a frequency change process of FIG. 10.

Referring to FIG. 10, the processor 170 (see FIG. 1) of the controller 10 may radiate the microwaves into the insertion space IS by controlling the source unit 20 and/or the antenna 320 (S1010). The processor 170 may receive reflected waves reflected from the insertion space IS after being radiated through the source unit 20 and/or the antenna 320. The processor 170 may analyze power of the received reflected waves, etc. (S1020). The characteristics of the microwaves being radiated and the reflected waves being received under the control of the processor 170 may be understood with reference to the above description related to FIG. 1.

The processor 170 may compare the power of the received reflected waves with a preset threshold value or threshold range. When the power of the received reflected waves is greater than the preset threshold value or is outside the preset threshold range (“Yes” in S1030), the processor 170 may change the frequency of the microwaves radiated from the antenna 320 by controlling the source unit 20 and/or the antenna 320 (S1040). When the frequency of the microwaves radiated from the antenna 320 is different from the resonant frequency of the insertion space IS into which the aerosol-generating article 2 is inserted, the power of the received reflected waves may be greater than the preset threshold value or outside the preset threshold range. In other words, when the frequency of the radiated microwaves is different from the resonant frequency by more than a certain allowable range, the processor 170 may change the frequency of the microwaves radiated from the antenna 320.

The processor 170 may change the frequency of the microwaves radiated from the antenna 320 to correspond to the resonant frequency while repeating processing of S1010 to S1040.

When the power of the received reflected waves is less than the preset threshold value or falls within the preset threshold range (“No” in S1030), the processor 170 may maintain the frequency of the microwaves radiated from the antenna 320 by controlling the source unit 20 and/or the antenna 320 (S1050). When the frequency of the radiated microwave is the same as the resonant frequency or a difference between the frequencies is within a certain allowable range, the processor 170 may maintain the frequency of the microwaves radiated from the antenna 320.

Accordingly, the frequency radiated from the antenna may be easily changed to match variation of the resonant frequency, and it is possible to prevent heating efficiency from being reduced or the device from failing due to reflected waves.

Referring to FIG. 11, the processor 170 may change the frequency of the microwaves radiated from the antenna 320 by controlling the source unit 20 and/or the antenna 320. When the power of the received reflected waves is greater than a preset threshold value or is out of a preset threshold range, the processor 170 may change the frequency of the microwaves by preferentially controlling the source unit 20.

The processor 170 may determine whether the review of the RF signal is completed (S1041). The review of the RF signal means changing the frequency of the microwaves while sweeping the RF signal output from the source unit 20 within a changeable range or a set frequency band. For example, the RF signal may be sequentially changed into 10 different signals within a changeable range or a set frequency band, and the frequency of the microwaves may be changed into 10 different frequencies by each of the 10 RF signals that are changed. When the RF signal generated by the source unit 20 is changed while changing the frequency of the microwaves within the changeable range, the review of the RF signal is defined as completed, otherwise, the review of the RF signal may be defined as not completed.

When the review of the RF signal is not completed (“No” in S1041), the processor 170 may change the RF signal within the changeable range or the set frequency band (S1042). The RF signal may be changed to a value that has not yet been changed within the changeable range or the set frequency band. Thereafter, the processor 170 may perform a control operation so that the microwaves are radiated according to the changed RF signal, receive the reflected waves, determine the power of the reflected waves, and determine whether the power of the reflected waves is greater than the threshold value or out of the threshold range.

When the review of the RF signal is completed (“Yes” in S1041), the processor 170 may perform a control operation so that the length or the shape of the antenna 320 is changed (S1043). The processor 170 may perform a control operation so that the length or the shape of the antenna 320 is changed within a changeable range. For example, the length or the shape of the antenna 320 may be sequentially changed to three different lengths or shapes within a changeable range, and the frequency of the microwaves may be changed by each of the three changed lengths or shapes. The feature of changing the length or shape of the antenna 320 by the control of the processor 170 may be understood with reference to the above description related to FIGS. 5, 7, and 9.

When the length or the shape of the antenna 320 is changed, the processor 170 may repeatedly perform a process of changing the frequency of the microwaves while sweeping the RF signal within a changeable range or a set frequency band. In other words, even when the power of the reflected waves does not become smaller than the threshold value or is not included within the threshold range by changing the frequency of the RF signal, the frequency of the microwaves radiated from the antenna 320 may be changed to correspond to the resonant frequency by repeating a process of changing the frequency of the RF signal while gradually changing the length or the shape of the antenna 320.

Accordingly, a range in which the frequency of the microwaves radiated from the antenna 320 may be changed may be expanded compared to the case where only the RF signal is controlled, and the frequency of the microwaves radiated from the antenna may be easily changed in response to change in the resonant frequency.

As described above, according to at least one of the embodiments of the present disclosure, the frequency radiated from the antenna may be easily changed by performing a control operation so that at least one of the length or the shape of the antenna is changed.

According to at least one of the embodiments of the present disclosure, the antenna includes a plurality of tracks and includes a track switch, which electrically connects or disconnects tracks, between the respective tracks, so that the length and the shape of the antenna may be easily changed.

According to at least one of the embodiments of the present disclosure, the driver connected to one end of the antenna and configured to extend or shorten the antenna in one direction is provided, so that the length and the shape of the antenna may be easily changed.

According to at least one of the embodiments of the present disclosure, by changing the length or the shape of the antenna and the output RF signal based on the power of the reflected waves, the frequency of the microwaves radiated from the antenna may be easily changed to match variation of the resonant frequency, and it is possible to prevent heating efficiency from being lowered or prevent the device from failing due to the reflected waves.

Referring to FIG. 1 to FIG. 11, an aerosol-generating device 1 may include a body 11 providing an insertion space IS in which an aerosol-generating article 2 is accommodated, an antenna 320 disposed adjacent to the insertion space IS and configured to radiate microwaves that dielectrically heat the aerosol-generating article 2 into the insertion space IS, and a controller 10 configured to control a frequency of the microwaves radiated from the antenna 320, wherein the antenna 320 may have a changeable length and shape, and the controller 10 may be configured to change the frequency radiated from the antenna 320 by controlling at least one of the length or the shape of the antenna 320 to be changed.

In addition, according to another aspect of the present disclosure, the antenna 320 may have a meandering shape.

In addition, according to another aspect of the present disclosure, the antenna 320 may include a first track 321, and a second track 322 selectively connectable to the first track 321.

In addition, according to another aspect of the present disclosure, the aerosol-generating device 1 may include an antenna adjuster 40 connected to the first track 321 and the second track 322 and configured to adjust the length and the shape of the antenna 320.

In addition, according to another aspect of the present disclosure, the antenna adjuster 40 may include a track switch 410 disposed between the first track 321 and the second track 322 and configured to switch connection between one end of the first track 321 and one end of the second track 322.

In addition, according to another aspect of the present disclosure, the controller 10 may be configured to control the track switch 410 to electrically connect or electrically disconnect the first track 321 and the second track 322.

In addition, according to another aspect of the present disclosure, the aerosol-generating device 1 may include a shielding portion 330 surrounding an outside of the antenna 320, wherein the controller 10 may be configured to control the track switch to electrically disconnect the first track 321 and the second track 322, and electrically connect the second track 322 to the shielding portion 330.

In addition, according to another aspect of the present disclosure, the antenna 320 may include a helical antenna 320.

In addition, according to another aspect of the present disclosure, the aerosol-generating device 1 may include an antenna adjuster 40 connected to the helical antenna and configured to move one end of the helical antenna in a longitudinal direction of the helical antenna to adjust a length and a pitch of the helical antenna.

In addition, according to another aspect of the present disclosure, the antenna adjuster 40 may include a driver 420 connected to the one end of the helical antenna and configured to drive in a forward direction or a reverse direction to increase or decrease the length and the pitch of the helical antenna.

In addition, according to another aspect of the present disclosure, the aerosol-generating device 1 may include a source unit 20 configured to transmit an RF signal to the antenna 320, wherein the controller 10 may be configured to compare power of reflected waves received through the antenna 320 with a threshold value, and controlling the RF signal output from the source unit to change the frequency of the microwaves radiated from the antenna 320, based on the power of the reflected waves being greater than the threshold value.

In addition, according to another aspect of the present disclosure, the controller 10 may be configured to control the source unit to change the RF signal output from the source unit 20 within a set frequency band, determine power of the reflected waves according to change of the RF signal, and control the length or the shape of the antenna 320 to be changed when the power of the reflected waves is not less than the threshold value.

In addition, according to another aspect of the present disclosure, the antenna 320 may be formed of an elastic material.

Certain embodiments or other embodiments of the disclosure described above are not mutually exclusive or distinct from each other. Any or all elements of the embodiments of the disclosure described above may be combined with another or combined with each other in configuration or function.

For example, a configuration “A” described in one embodiment of the disclosure and the drawings and a configuration “B” described in another embodiment of the disclosure and the drawings may be combined with each other. Namely, although the combination between the configurations is not directly described, the combination is possible except in the case where it is described that the combination is impossible.

Although embodiments have been described with reference to a number of illustrative embodiments thereof, it should be understood that numerous other modifications and embodiments can be devised by those skilled in the art that will fall within the scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. An aerosol-generating device comprising:
a body providing an insertion space in which an aerosol-generating article is accommodated,
an antenna disposed adjacent to the insertion space and configured to radiate microwaves that dielectrically heat the aerosol-generating article into the insertion space; and
a controller configured to control a frequency of the microwaves radiated from the antenna, wherein:
the antenna has a changeable length and shape, and
the controller is configured to change the frequency radiated from the antenna by controlling at least one of the length or the shape of the antenna to be changed.

2. The aerosol-generating device according to claim 1, wherein the antenna has a meandering shape.

3. The aerosol-generating device according to claim 2, wherein the antenna comprises:
a first track; and
a second track selectively connectable to the first track.

4. The aerosol-generating device according to claim 3, comprising an antenna adjuster connected to the first track and the second track and configured to adjust the length and the shape of the antenna.

5. The aerosol-generating device according to claim 4, wherein the antenna adjuster comprises a track switch arranged between the first track and the second track and configured to switch connection between one end of the first track and one end of the second track.

6. The aerosol-generating device according to claim 5, wherein the controller is configured to control the track switch to electrically connect or electrically disconnect the first track and the second track.

7. The aerosol-generating device according to claim 6, comprising a shielding portion surrounding an outside of the antenna,
wherein the controller is configured to control the track switch to electrically disconnect the first track and the second track, and electrically connect the second track to the shielding portion.

8. The aerosol-generating device according to claim 1, wherein the antenna comprises a helical antenna.

9. The aerosol-generating device according to claim 8, comprising an antenna adjuster connected to the helical antenna and configured to move one end of the helical antenna in a longitudinal direction of the helical antenna to adjust a length and a pitch of the helical antenna.

10. The aerosol-generating device according to claim 9, wherein the antenna adjuster comprises a driver connected to the one end of the helical antenna and configured to drive in a forward direction or a reverse direction to increase or decrease the length and the pitch of the helical antenna.

11. The aerosol-generating device according to claim 1, comprising a source unit configured to transmit an RF signal to the antenna,
wherein the controller is configured to:
compare power of reflected waves received through the antenna with a threshold value, and
control the RF signal output from the source unit to change the frequency of the microwaves radiated from the antenna, based on the power of the reflected waves being greater than the threshold value.

12. The aerosol-generating device according to claim 11, wherein the controller is configured to:
control the source unit to change the RF signal output from the source unit within a set frequency band,
determine power of the reflected waves according to change of the RF signal, and
control the length or the shape of the antenna to be changed when the power of the reflected waves is not less than the threshold value.

13. The aerosol-generating device according to claim 1, wherein the antenna is formed of an elastic material.
